(19) United States
(12) Patent Application Publication
(10) Pub. No.: US 2012/0203566 A1
(43) Pub. Date: Aug. 9, 2012

(54) SYSTEM AND METHOD FOR PROVIDING ELECTRONIC ORDERS FOR MEDICAL EQUIPMENT

(75) Inventors: Randy Kidd, Brownsburg, IN (US); John J. Brady, Zionsville, IN (US)

(73) Assignee: STRATICE LLC, Indianapolis, IN (US)

(21) Appl. No.: 13/335,162

(22) Filed: Dec. 22, 2011

Related U.S. Application Data
(60) Provisional application No. 61/426,804, filed on Dec. 23, 2010.

(51) Int. Cl. G06Q 50/22; G06Q 10/08

(52) U.S. Cl. 705/2

(57) ABSTRACT

A system and method for providing medical equipment includes providing a system utilizing computer software that electronically collects, validates, and processes a patient's data including medical equipment or other durable medical goods ordered by a physician and patient's billing information from a third party provider request. The system and method may also be capable of electronically sending an order including the patient's data to a third party supplier.

This application claims priority to U.S. Provisional Patent Application No. 61/426,804, filed on Dec. 23, 2010, entitled SYSTEM AND METHOD FOR PROVIDING ELECTRONIC ORDERS FOR MEDICAL EQUIPMENT.

### FIELD OF THE INVENTION

An electronic ordering system as a method to provide medical equipment and other durable medical goods to patients is provided. Specifically, a system for electronically interfacing a patient's electronic medical records and a patient's health records, from their physician to healthcare providers such as, medical equipment suppliers is provided.

### BACKGROUND OF INVENTION

Durable medical goods, such as diabetes testing strips, are generally prescribed to a patient at a physician's office, but unlike pharmaceutical prescriptions that can be phoned into a pharmacy or sent directly from a physician's office, it is often left to the patient to seek out individual durable medical goods providers, obtain the goods, and to arrange for payment. As a result, in many cases, the medical goods are not obtained by the patient and the patient does not receive the care envisioned by the physician. Therefore, a system that would alleviate the patient's burden would increase adherence to a physician's directives and the level of care received by the patient.

### SUMMARY OF INVENTION

A method and system of providing medical goods is provided. The method includes providing a system utilizing a computer that is configured to electronically collect data elements from a third party provider, wherein the data elements collected from the third party provided have been obtained by the third party provider from a patient or a patient's medical provider, and wherein the data elements identify the medical good to be provided to the patient. The method also includes validating the data elements sent to the system, creating an order from the data elements sent to the system, and sending the order from the system to a third party supplier of medical goods; wherein the third party supplier of medical goods is capable of providing the medical goods to the patient and obtaining payment for the medical goods.

### DESCRIPTION OF THE DRAWINGS

FIG. 1 is a graphical representation of a system for electronically providing medical equipment.

FIG. 2 is a graphical representation of a system for electronically providing medical equipment.

FIG. 3 is a graphical representation of a system for electronically providing medical equipment.

FIG. 4 is a graphical representation of a system for electronically providing medical equipment.

FIG. 5 is a graphical representation of a system for electronically providing medical equipment.

FIG. 6 is a graphical representation of a system for electronically providing medical equipment.

FIG. 7 is a graphical representation of a third party supplier selection routine.

FIG. 8 is a graphical representation of a system for electronically providing medical equipment.

FIG. 9 is a graphical representation of a system for electronically providing medical equipment.

### DETAILED DESCRIPTION

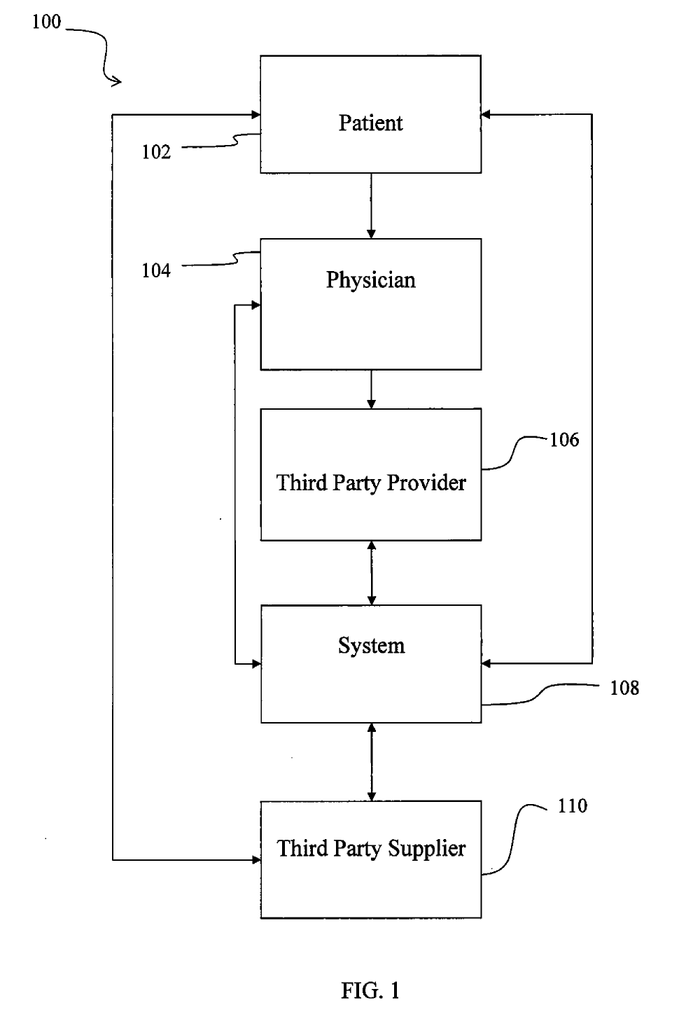

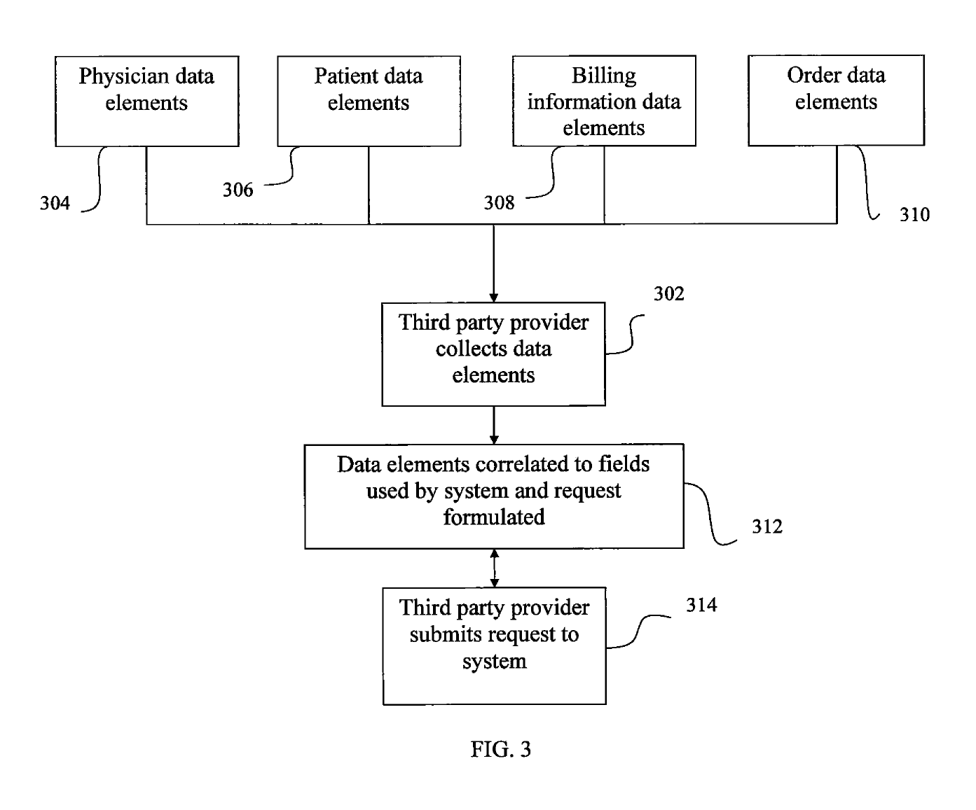

Referring to FIG. 1, a system 100 and method for providing durable medical equipment, such as diabetic test strips, blood glucose monitors, and the like, to patients 102 is provided. The method includes a medical care provider, such as a physician 104 obtaining data from the patient 102, which is in turn provided to a third party provider 106, such as an electronic medical record (EMR) service or patient health record (PHR) service. This application will speak in terms of the medical care provider being a physician, but it should be understood that other medical care providers, such as those employed by clinics, hospitals, in private practice, physical therapists, home healthcare services, nursing facilities, rehabilitation centers, and the like, are contemplated. As shown in FIG. 1, the method also includes providing a system 108 configured to obtain the patient's 102 data from the third party provider 106 and process the data received to identify data elements (as shown in FIG. 3), such as the patient's billing information and the identity of the durable medical equipment prescribed by a physician 104 for the patient 102.

The system 108 is configured to use the data elements obtained from the third party provider 106 to electronically order the durable medical equipment on the patient's 102 behalf from a third party supplier 110 and provide the third party supplier 110 with the patient's 102 billing information so that the patient 102, Medicare, Medicaid, or an insurance provider can be billed directly. The system 108 may also electronically collect and track patient 102 information and feedback, such as blood glucose readings, through a patient access portal, which may be monitored and updated by both the patient 102 and the patient's physician 104 (including the physician's office or hospital staff).

For the purpose of illustration only, this system will be described for use in supplying medical equipment ordered by the physician 104 to a patient 102 diagnosed with diabetes. It should be appreciated that this system 108 may be used to supply patients 102 with a variety of durable medical equipment (including but not limited to sleep apnea supplies, incontinent supplies, ostomy supplies, catheters, oxygen, wheel chairs, walkers, and lift chairs), based on the patient's 102 individual diagnosis or need. In this embodiment, the system 108 is configured to collect data elements from a third party provider 106 such as an electronic medical record service or patient health record service using a network of computers or other suitable electronic means, as described below.

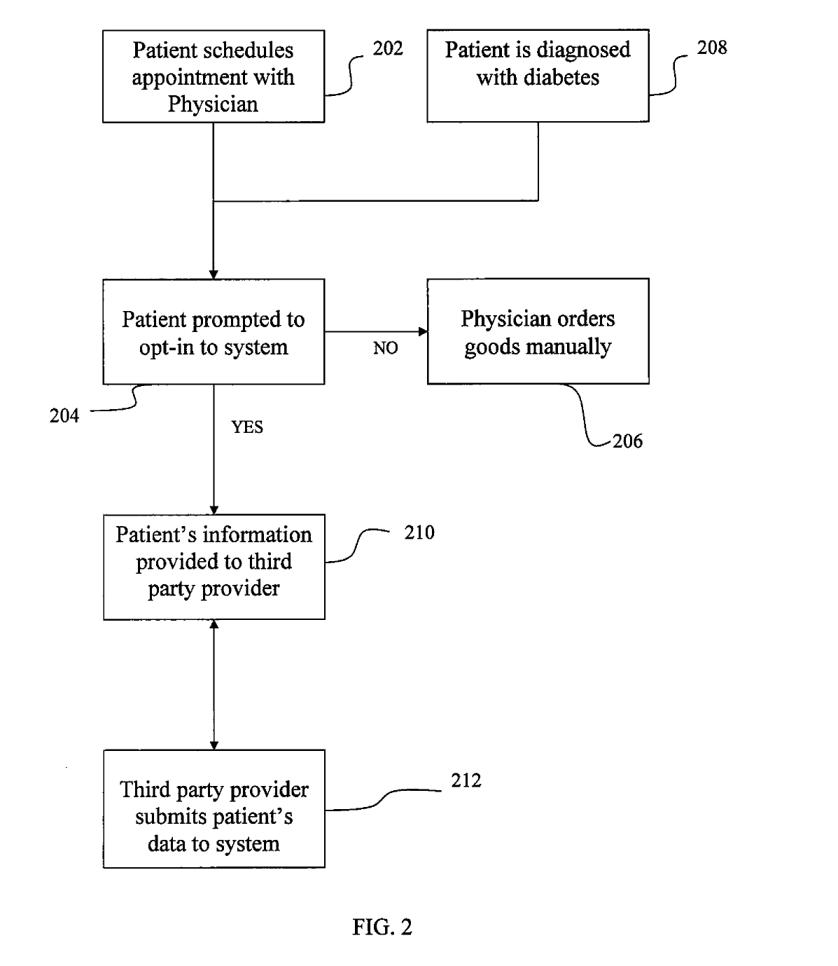

As shown in FIG. 2, in one embodiment, when a diabetic patient schedules an appointment with a physician's office 202, either for the first time or for the first time after the physician has implemented the system that that allows the physician to automatically provide his or her patient's with diabetes test equipment, blood glucose monitors, or other durable medical equipment, the patient may be prompted to “opt-in” to the system 204. If the patient does not agree to opt-in to the system, the physician can manually provide the patient with a prescription for the medical goods 206. When the patient agrees to use the system to receive such goods and services, etc., either the physician's office or the patient can input that selection through the third party provider's software, which has been customized to receive the data indicating that this choice has been made. It should be appreciated that the patient may opt-in at two different times; the first is to “opt-in” to the system 204 during the patient's registration process with the physician 202. In another embodiment, the patient may opt-in to the system 204 when the patient is diagnosed with diabetes 208, at which point the physician (or the physician's staff) can ask the patient to opt-in to the system and then submit the patient's data related to their diagnosis to the system through the third party provider 210.

The patient's data may be provided to the third party provider through an electronic interface (not shown), indicating that the patient has chosen to use the system to provide the recommended medical equipment. This data is entered into a data sheet or interface provided by the third party's computer software. The third party provider may be an electronic medical record provider. An electronic medical record (EMR) is a record in digital format that is capable of being shared across different health care settings, by being embedded in network-connected enterprise-wide information systems. Such records may include a whole range of data in comprehensive or summary form, including demographics, medical history, medication and allergies, immunization status, laboratory test results, radiology images, and billing information.

EMRs can be a part of a local stand-alone health information system, a hosted system, a single instance multi-tenant (cloud) system, or the like, that allows storage, retrieval and modification of records. Using an EMR to read and write a patient's record is not only possible through a workstation but depending on the type of system and health care settings may also be possible through mobile devices that are handwriting capable or can be browser based applications. EMRs may include access to Personal Health Records (PHR) which makes individual notes from an EMR readily visible and accessible for patients. Each healthcare environment functions differently, often in significant ways. Generally, an EMR system will have standardized records but interfaces that can be customized to each provider environment.

The third party provider's software may be loaded onto or reside on the physician's computer or electronic mobile device. The third party provider can also include hosted applications. The third party provider's software and/or service may or may not reside on the physician's local computer or device. It is contemplated, that the third party provider's software may be hosted remotely to the physician's office, as discussed above. In one embodiment, the third party provider's software may collect patient data via an electronic interface on the physician's computer. The data is then submitted to the system 212.

As shown in FIG. 3, the patient's data is provided to the third party provider in the form of data elements 302 that relate to the physician 304, patient 306, billing 308, and order data 310. The data elements 302 are obtained from the information inputted into the third party provider's computer software at the physician's office 210 (as shown in FIG. 2). The data elements 302 collected via the third party provider's computer software may be interpreted by the third party provider 106 using a data dictionary to correlate the third party provider's field mappings to those fields used by the system. The third party provider's computer software will generally support REST (representational state transfer), SOAP (simple object access protocol) based outbound\inbound calls, SFTP (SSH file transfer protocol) batch uploads or downloads, and HTTPS POST formatted outbound\inbound calls to the system.

Physician data elements 304 may include, but are not limited to the physician's name, address, area of specialization, national provider identifier (NPI Number), the physician visit notes (SOAP Notes), the electronic physician signature, and source system ID. Patient data elements 306 may include, but are not limited to the patient's name, address, and the third party provider patient record source system ID. Billing information data elements 308 may include, but are not limited to payment type, credit card number, Medicare part B information, insurance company identification, and source system ID. Order data elements 310 include, but are not limited to, the product type, ICD details (International Statistical Classification of Diseases and Related Health Problems), “CMN” specific fields (certificate of medical need), and source system ID.

The third party provider creates the original request for durable medical equipment. When responding to the third party provider with transaction or status updates the system may store the third party provider-specific transaction numbers or IDs to more easily and efficiently correlate the related response or status transactions back to the originating transaction. A source system ID may also be stored for the supplier-specific records or transaction sent via the system. Source system IDs are used to allow a transaction to be correlated to its source, i.e. either the physician, third party provider, or the supplier, when updates are sent back to the source of this data

When the third party provider processes the data elements and determines that the patient has been diagnosed or is an existing candidate for the diabetes test strips and equipment or other durable medical goods, the third party provider may send the system a request 314 to fulfill the physician's order.

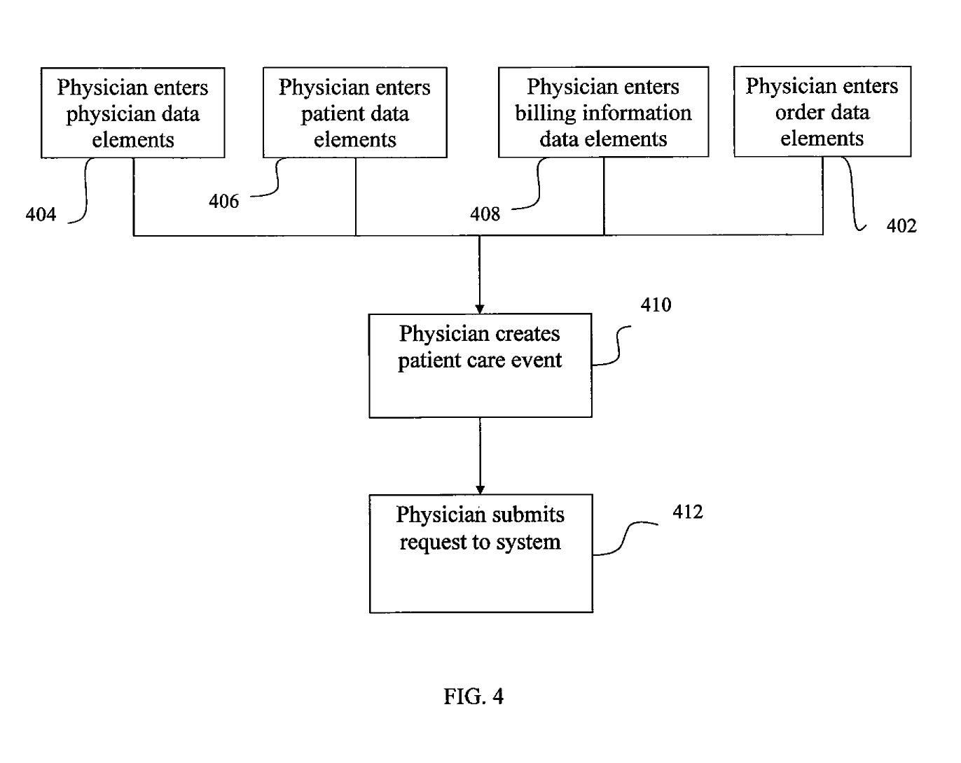

In another embodiment, shown in FIG. 4, a physician may trigger a request by either 1) creating a patient “care event” or 2) ordering a specific type of good, such as a blood glucose monitor. A patient care event is an EMR record that has a diagnoses code (ICD-9, soon to be ICD-10) that indicates the patient has a condition that is directly deterministic to a device to monitor, maintain or treat that condition. For example, an ICD-9 code in the 250.xx family identifies a diabetic patient and requires the patient to have a diabetes monitor, test strips supplies, etc. Typically the physician does not prescribe the specific brand of durable medical good to be provided, that will be done by the supplier based upon the data elements provided in the request and using the payer durable medical equipment benefits available to the patient.

As shown in FIG. 4, the request can be sent by the physician directly to the system. For example, a physician may input the order data elements 402 that correspond to diabetic test strips by inputting the ICD code of 205.XX. The entry of the ICD code by the physician is just a trigger to alert the physician that the patient is eligible for certain durable medical equipment. Alternatively, as discussed above, the physician can also explicitly select this device from a list of potential devices.

The system may also use a schedule process to make a SOAP, REST, HTTPS or SFTP request into the third party provider to retrieve these order data elements marked for processing by the third party provider. For example, the third party provider can mark a record as an order that should be created, but because the third party provider does not have the capability to create this record, the system can be configured to be automatically activated at a set time and make an electronic call to the third party provider, or the third party provider's designated location, to obtain this data. The call may be made using SOAP or REST based web services calls, HTTPS requests, an SFTP pull, or other suitable means.

This inbound or outbound request will be made using HL7, CCD, XML, CSV, JSON or other suitable electronic format. The request will generally contain physician data elements 404, patient data elements, 406, and billing data elements 408. The data elements are then used to create the request 410 and sent directly to the system 412.

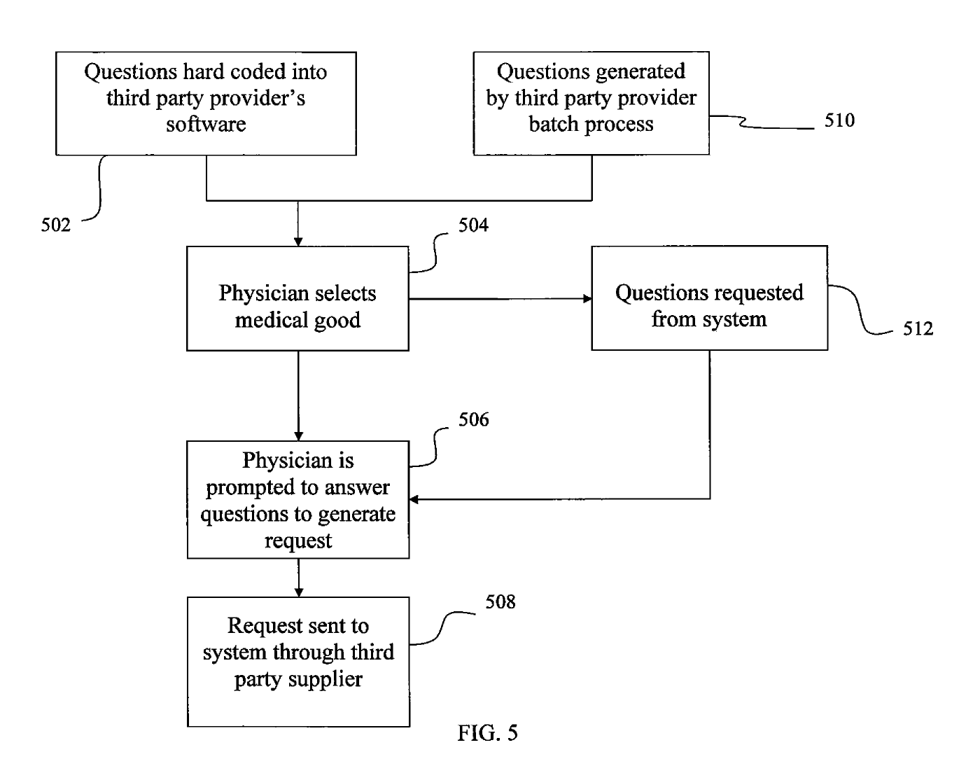

As shown in FIG. 5, the data elements that correspond to the order data can include the answer to a number of questions specific to the type of good to be provided. These questions can be provided to the supplier in a number of ways. In one embodiment, the third party provider's software located on the physician's computer will include a list of questions for each product type. These questions can be hard coded into the third party provider's software 502 such that when a physician selects a specific product type 504, such as a blood glucose monitor, the questions are displayed and the physician can answer 506. The answers to the questions are then sent as part of the request to the system via the third party provider 508.

In another embodiment, a batch process (the execution of a series of programs on a computer without manual intervention) is allowed to work at a configured interval that will send or update the questions for a specific product type or group of product types 510. In this case the third party provider or software vendor will create a process to store this information local to the third party provider's software and then provide the physician with the most recent set of questions and allow the physician to answer.

In yet another embodiment, the third party provider or software vendor requests the questions 512 each time the physician selects a product category 504. For example, when the physician selects “wheelchair” the third party provider will send a request to the system to get the most recent questions and display them for the physician. The physician can then answer the questions 506 and send the results to the system 508.

When the questions are generated by the system, however, specific suppliers can override one to many of these questions based on their specific requirements. For example, a first supplier may choose to use as the standard question “how much does the patient weigh”—while a second supplier might as the standard question “how much does the patient weigh” as well as “what is the patient's BMI.”

The system may reject a request based on specific answers to CMN questions. So, if a physician sends an immediate (synchronous Web Services) request and the CMN questions answers “No” to a question that requires a “Yes,” the physician and patient can immediately be informed that the patient does not qualify for this product.

These supplier questions and automated responses can be maintained by the supplier via the system portal. These questions and responses are also based on the payer. Therefore, the question and answer requirements may differ for public and private insurance carriers.

The request may be sent to a server maintained by the system from a server maintained by the third party provider via a secure network connection via Secure Socket Layer (SSL). Security measures for the transmission of the patient's data may include multiple layers of security, such as IP filtering, public/private key for the transport, and user ID/password and/or token authentication.

Referring again to FIG. 1, the system 108 may use computer software running on a third parties' cloud computing technology-based infrastructure to facilitate the transfer of the data pulled\pushed from the third party provider 106 to the supplier 110. Cloud computing is Internet-based computing, whereby shared resources, software, and information are provided to computers and other devices on demand, like the electricity grid. It should be understood that the system 108 may utilize other suitable types of infrastructure, including but not limited to single instance multi-tenant or privately hosted systems.

Cloud computing is a supplement, consumption, and delivery model for IT services based on the Internet, and it typically involves over-the-Internet provision of dynamically scalable and often virtualized resources. Cloud technology frequently takes the form of web-based tools or applications that users can access and use through a web browser as if it was a program installed locally on their own computer. Typical cloud computing providers deliver common business applications online that are accessed from another Web service or software like a Web browser, while the software and data are stored on servers.

Most cloud computing infrastructures consist of services delivered through common centers and built on servers. Clouds should meet quality of service (QoS) requirements of customers and include service level agreements (SLAs). Cloud service providers include, but are not limited to Microsoft™, Hewlett Packard™, IBM™, Salesforce™, Amazon™, and Google™.

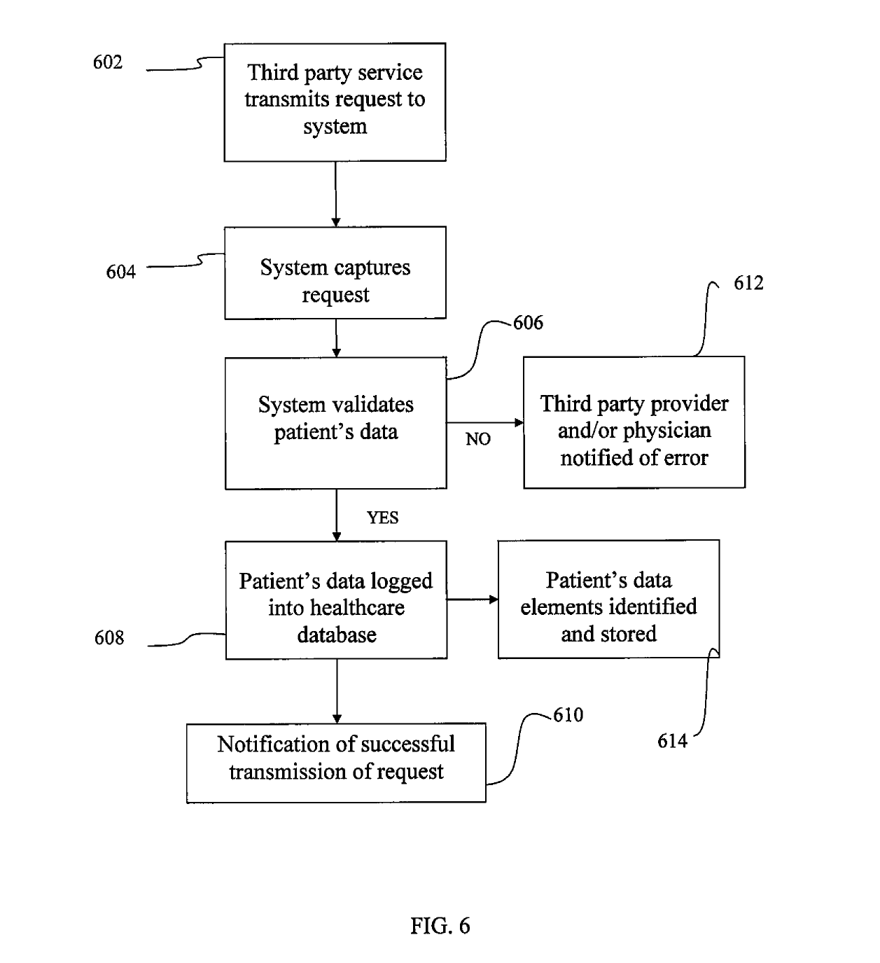

Referring now to FIG. 6, upon transmission of the request from the third party provider 602, the system, utilizing computer software program, captures 604 and validates 606 the patient's data received from the third party provider. The data may be validated using a combination of code (such as XSLT code logic and schema validation) and database logic. The logic may be configurable based on the supplier of medical equipment chosen by the system's computer software or program, the physician's requirements, and the EMR service's requirements. When the data has been validated by the system's computer software 606, the data is logged into the system's healthcare data base 608 and the third party provider and/or the physician is notified that the data has been received successfully 610. The system may utilize a system administrator to make this notification. The system administrator may be notified via email or other electronic means if there was an error in logging and/or validating the patient's data. If there was an error, the system or the system administrator may be capable of notifying the third party provider and/or the physician 612.

In one embodiment, there is an abbreviated version of the validation that the third party provider's computer software can use to verify if a specific order can be filled by a supplier in our the system's network. In this embodiment, all of the data elements prompted for validation are not required. The system only needs to be supplied with enough information to identify the product, the geographic location (City, State, Zip), and the payer for the order. This simplified request can be used by a physician via their third party provider to let a patient know in advance that the product can be filled. In this simplified request, the system will ensure the supplier selected has the product, capacity, quality score, geographic presence and payer contact to fill the order.

Referring again to FIG. 6, after the patient's data has been successfully validated 606 and logged into the system's healthcare data base 608, the system's computer software program may be utilized to parse the request sent by the third party provider, generally in HL7 or XML format, to identify the data elements sent in the request and store the patient's data in the system's healthcare database 614. The system's healthcare database may be a normalized SQL compliant database and the patient-specific data may be encrypted before it is stored in the healthcare database to protect the patient's confidential information.

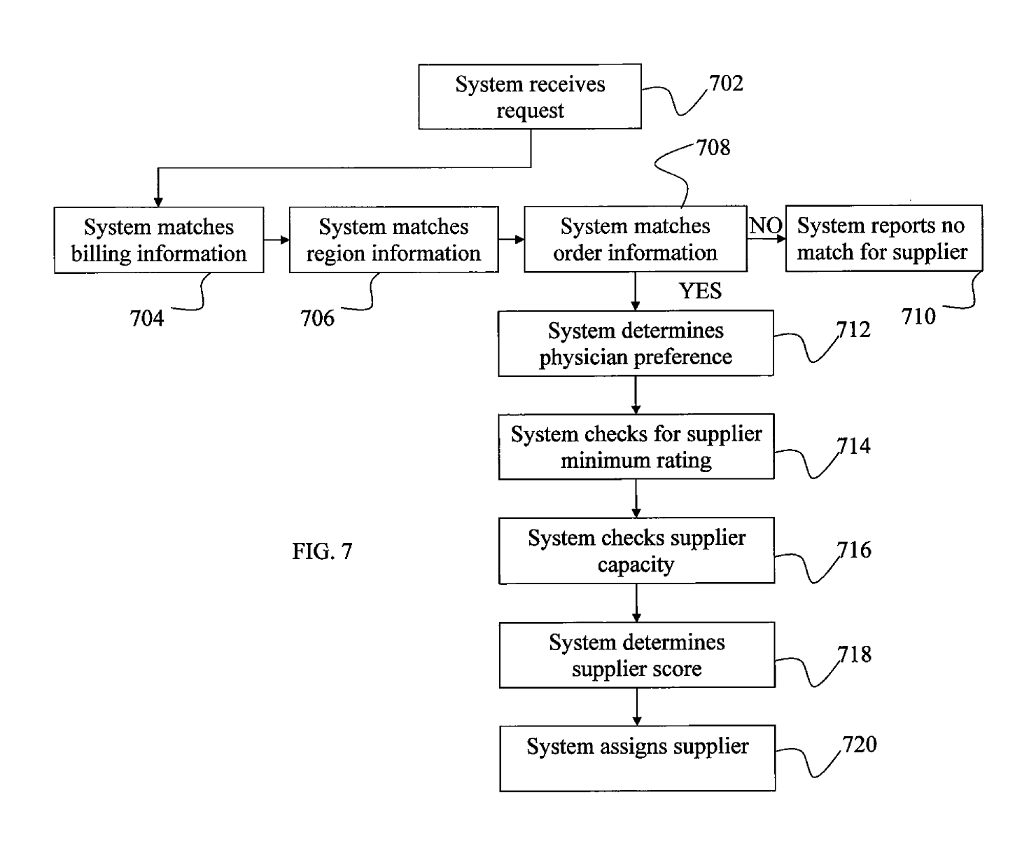

Referring again to FIG. 1, once parsed by the system's 108 computer software program, the system 108 will automatically generate an order to be electronically transmitted to a third party supplier 110. The order may be generated by the system 108 by utilizing the computer software to run a supplier selection routine. The supplier selection routine, as shown in FIG. 7, may generally include comparing supplier selection criteria, including physician preferences, patient cost, insurance coverage, device features requested, devices features required, device ratings, supplier data subscribed to supply, and supplier ratings to determine which third party supplier is best suited to timely and accurately deliver the patient's medical equipment or other durable medical goods.

The supplier selection routine may take into consideration the product to be supplied, the payer relationship to the supplier, the supplier's geographic presence, capacity to fill the order, patient rating, physician rating, system rating, physician device or supplier preferences, and all other suitable variables.

The supplier selection routine is used to choose between third party suppliers, whose information has been stored in the system's supplier data base, and populated by third party suppliers who have executed service level agreement with the service. As shown in FIG. 7, once the system receives a request from either a physician or a third party provider, the system uses the information stored in the system's supplier data base to match the patient's billing information 704, supplier location or region preference 706, and the order information 708 with the various suppliers in the system. If no supplier match is found, the system reports a “no match” to the third party provider 710.

If at least one supplier match is found, the system's supplier selection routine then considers the physician's preference for supplier 712, determines if the suppliers meet the minimum supplier rating required 714, and confirms the suppliers' capacity to fill the request 716. The supplier ratings of the third party suppliers that populate the supplier database may be determined by comparing the third party supplier's available capacity, historic and guaranteed response times, patient conversion rates, patient turnover, and patient cancel rate. Upon completion of these calculations, a supplier score is assigned 718 to each supplier that matches the above referenced criteria and a supplier is chosen based upon that score 720.

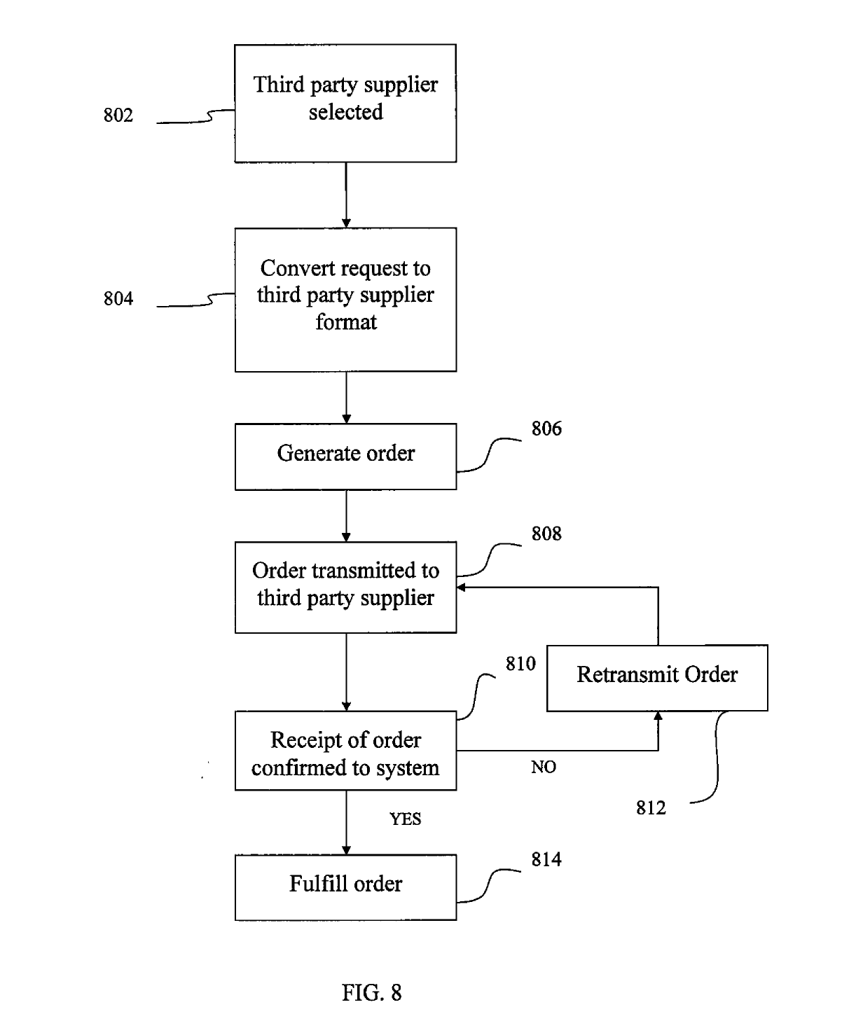

As shown in FIG. 8, when the third party supplier is identified by the system's supplier selection routine 802, the system's computer software may then transform the patient's data stored in the system's healthcare database and generally stored in a database table and sent in an HL7 or XML format, to a third party supplier specific order format 804 and an order is generated 806. The order is then transmitted to the third party supplier as an outbound transmission from the system 708.

The outbound transmission format is configurable based on the specific third party supplier and may be determined based on database logic, code logic, and XSLT. The outbound transmission may generally include the patient information, physician information, billing, device order, and device preferences, and other relevant information. The outbound transmission may be delivered in HTTPS POST, SOAP request, REST request, SFTP pull by the third party supplier, or by SFTP push format. The transmission may or may not use a VPN (Virtual Private Network) network for this transaction submission. Upon receipt of the outbound transmission by the third party supplier, the system is capable of receiving an electronic confirmation from the third party supplier 810. If the system does not receive a confirmation from the third party supplier, the transmission may be automatically resent to the third part supplier for a pre-configured number of times 812.

The outbound transmission occurs via a configurable scheduled job within the system. This configurable outbound transmission service allows the third party supplier to indicate a time delay for sending the request. This time delay can be set at zero allowing the outbound service transmission to act and appear synchronous.

Upon receipt of the confirmation from the third party supplier 810, the system updates its healthcare database to reflect the successful transmission of the patient's order to the third party supplier. The third party supplier is then responsible for contacting the patient, likely within 24 hours or one business day, to confirm the order information and billing information, shipping the patient's medical equipment, such as diabetes test strips and glucose monitoring systems, to the patient, and billing the patient or the patient's insurance including Medicare, Medicaid or other third party plans to ensure proper coverage for the cost of the medical equipment and related goods and services 814.

In this embodiment, the system is also configured to receive updates about the order from the third party supplier. The update to the system should include the time it took the third party supplier to contact the patient, likely within 24 hours, and the time it took to fulfill the patient's order, likely within 48 hours, and receive payment from the patient, or the patient's insurance. These criteria may be negotiated with the third party supplier as part of the SLA and therefore may vary based on supplier. The update of the order status from the supplier to the system may include shipping details, contacts, contact attempts, final order disposition, notes from each contact or contact attempt. The supplier may also reject the order. If the supplier rejects the order for any reason, the order is re-processed by the system to allow for another supplier selection process, this time eliminating the rejecting supplier from consideration. The system may also contain features to escalate or report on non-rejected or filled orders so a patient can be routed to another supplier for fulfillment of their request. The rejection of an order would be an “Order Status” sent from the third party supplier to the system.

Referring again to FIG. 1, the system 108 may also be configured to communicate with the patient 102, physician 104, and the third party supplier 110 through access portals. The access portal may be accessed via a traditional user interface or an interface on a public web-based service, mobile device, or other suitable electronic interface. The patient access portal may be configured to provide the patient 102 access to the patient's data stored in the system's 108 healthcare database. The patient 102 is able to log into the system 108 through the patient access portal to enter feedback about the third party supplier 110, including initial contact and delivery time and equipment quality information. The client's 102 feedback is then logged into the system's healthcare database. The patient 102 may also be able to record glucose meter readings in the system's 108 healthcare database in order to electronically monitor the patient's progress and medical information. The patient can also receive device specific training information for the supplies they have successfully ordered via the system 108.

The patient 102 could also use the patient access portal to request a refill of their durable medical equipment. The patient 102 request for a refill can be routed to the third party provider 106 to receive approval and electronic signature from the physician 104. In addition, the device usage information, such as the glucose meter readings entered by the patient 102, can also be sent to the third party provider 106 for display to the physician 104. The information is shared using the same techniques and technologies discussed above.

In another embodiment, the physician 104 and the third party provider 106 can be updated about the patient's feedback by automatically receiving an update transmission from the system 108 or by logging in to system 108 via the physician access portal. The physician 104 may also be able to log in to the system 108 via the physician access portal to update the physician's preferences for the patient 102 in the system's 108 healthcare database or to view the information about the patient's 102 glucose readings or other medical information entered by the patient into the system's 108 healthcare database. The update to the physician's preferences can then be used in the supplier selection routine for all future order fulfillments.

As discussed in FIGS. 1 and 5 above, the system 108 is able to both validate and log the data entered into its healthcare database by the patient 102 and the physician 104. The system 108 is capable of pulling and displaying the patient reading and fulfillment data from the system's 108 healthcare database using a web service. The data may be requested in SOAP request, REST, HTTPS POST, FTP Pull, HTML or raw data format. As an example, the data entered by the patient 102 about their blood glucose readings may include data that represents a unique patient identifier, time period for the readings taken, and a unique identifier for the physician 104.

The third party supplier 110 may be able to directly access the system 108 via a supplier access portal. The third party supplier 110 can use the supplier access portal to access the healthcare database to view pending orders by status and to export orders to the third party supplier's 110 system in a CSV format, PDF format, or other compatible format. The third party supplier 110 may also be able to use the suppler access portal to update order status and shipment details. The supplier 110 may also upload device specific training material for use by the patient receiving the device.

The supplier may also leverage the service 108 to send order status and shipment details via a SOAP, REST, HTTPS POST or SFTP web service submission. The supplier updates to the system 108 may include data that is used by the physician 104, the third party supplier 110, or the patient 102 to support Medicaid, Medicare or insurance compliance questions. As an example the system 108 may support an interface for diabetic patients considered High Frequency Testers. These testers are required to submit meter logs and reading at the request of Medicare. These logs can be gathered and stored within the system's 108 healthcare database.

The system 108 may be capable of verifying the physician's identification number such as NPI. This verification can reject an order prior to submission and require the physician to update the NPI or corresponding name prior to successful submission of the order. In addition, the system 108 may be programmed to create a report for supplies that are available from the network of suppliers 110 across a geographic region in order to evaluate the availability of specific devices prior to rejections. This enables the system 108 to automatically recruit new suppliers and inform physicians of potential rejections of specific request based on product availability.

In another embodiment, the system 108 allows for suppliers to upload specific check-out documents for a specific device to the system 108, such as support phone numbers, welcome guides, etc. When a patient order is then referred to that supplier by the system 108, those checkout materials can be electronically delivered to the physician and are available for print to give to the patient, allowing the patient to leave the physician's office with a welcome packet and contact information.

In another embodiment, the system 108 allows for the configuration of SMS, email, and other electronic notifications on status change events for a patients order. These notifications can be sent to the physician, patient, or supplier. Other non-status events are also available for orders such as refill dates and service cancellations.

The system may also allow the supplier to create a matrix of product, payer and geography configurations. These configurations allow the supplier to indicate which products they can supply in what region of the country and for what payment methods. Regions can be further defined by the supplier to allow the supplier to create their own specific geographic grouping. An example, Supplier A might supply diabetes test strips and supplies in the Northeast region only and sleep apnea equipment in the Southwest region only. So the supplier can then define the Southwest region to mean specific states, cities, area codes or zip codes and will only receive orders for which this supplier has the ability to fill.

The system also provides transactional billing capabilities. These capabilities are not for billing the payer for the actual order but determine the accounts receivable and accounts payable requirements for the different transaction types being sent across the system. In addition, the system may also be configured to verify eligibility of an order, depending on the payers selected by the patient. For example, when a request for a diabetic order comes across the platform, they system can identify the payer and determine if the payer will compensate the supplier for the specific order. If they do, the system then determines that it is appropriate to send the order to supplier. If the patient does not qualify for reimbursement for the product, the order may be automatically rejected and sent back to the physician along with the reason for rejection.

The system may be configured to use a publish and subscribe technique for determining which transaction the third party provider or supplier will send or receive as part of the system. For example, if the third party provider does not subscribe to receive meter reading documents from a patient, then those transactions are not sent to the third party provider even if they are created by the patient or the third party supplier. A registry of all third party provider and supplier partners may be created to understand which third party provider or supplier publishes and subscribes to each document type.

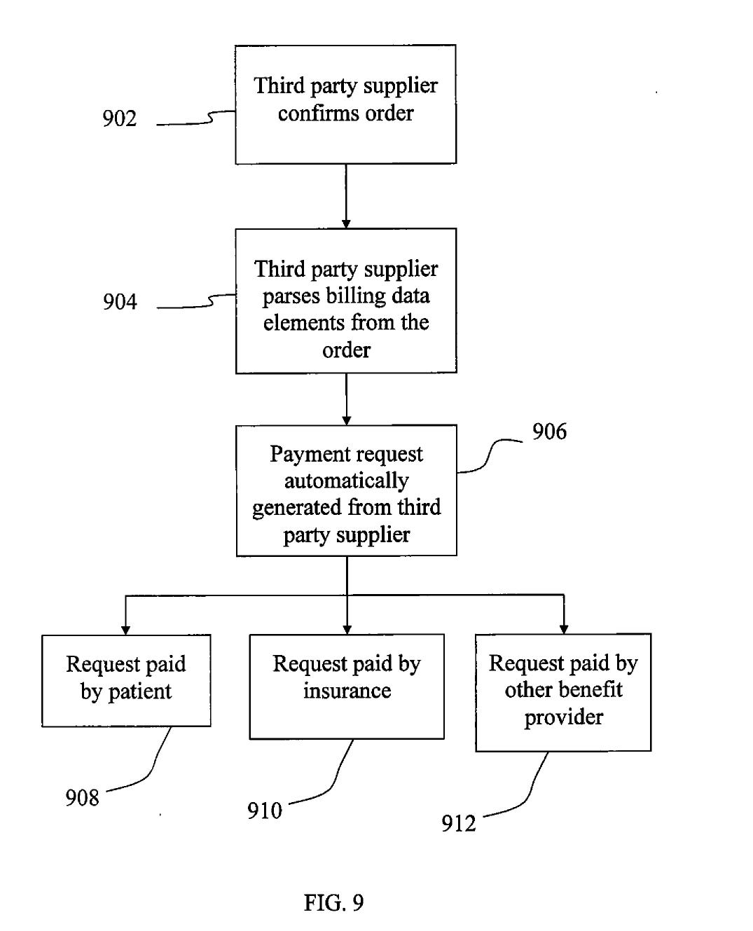

As shown in FIG. 9, once an order has been created by the system, sent to the third party supplier, and confirmed to the system, the provider will work directly with the payer and/or the patient to receive payment. As shown in FIG. 9, once the third party supplier confirms the order has been received 902, the third party supplier will then use the billing data elements contained in the order 904 to generate a payment request 906. The payment request may go directly to the patient 908, to the patient's insurance 910, or other medical benefit provider 912.

Although the system has been described with respect to a limited number of embodiments, many more variations will be readily apparent to those of skill in the art in accordance with the overall teaching and scope of this invention. For example, the system may be used to monitor and provide medical equipment to patients diagnosed with a variety of conditions.

1. A method of providing medical goods, comprising:
providing a system utilizing a computer, the system configured to electronically collect data elements from a third party provider, wherein the data elements collected from the third party provided have been obtained by the third party provider from a patient or a patient's medical provider and wherein the data elements identify the medical good to be provided to the patient;
validating the data elements sent to the system;
creating an order from the data elements sent to the system;
automatically executing a third party supplier selection routine to select a third party supplier of medical goods; wherein the third party supplier of medical goods is capable of providing the medical goods to the patient and obtaining payment for the medical goods; and
sending the order from the system to the third party supplier of medical goods that is chosen by the third party selection routine.

2. The method of claim 1, wherein the method further includes confirming to a third party provider that the data elements have been received by the system.

3. The method of claim 1, wherein the method further includes providing a patient access portal to provide access to the system to the patient, the physician, and the third party provider.

4. The method of claim 3, wherein the patient access portal of the system is configured to receive feedback from the physician or the patient corresponding to a third party supplier rating.

5. The method of claim 3, wherein the patient access portal of the system is configured to transmit patient data from the patient to the physician.

6. The method of claim 5, wherein the patient data includes medical device readings.

7. The method of claim 1, wherein method further includes providing a supplier access portal to provide access to the system to the third party supplier.

8. The method of claim 7, wherein the system is configured to receive feedback from the third party supplier regarding a status of the order.

9. The method of claim 1, wherein the data elements include patient data elements, physician data elements, order data elements, and billing data elements.

10. The method of claim 9, wherein the data elements are collected by the system utilizing a set of questions and associated answers generated by the system, and wherein the system is configured to present the set of questions to the physician or the third party provider through a computer interface.

11. The method of claim 1, wherein the third party supplier selection routine of the system is configured to compare the data elements collected from the third party supplier with information stored in a supplier selection database to select the third party supplier.

12. A system for providing medical equipment comprising:
a system utilizing a computer, the system configured to electronically collect data elements from a third party provider, wherein the data elements collected from the third party provided have been obtained by the third party provider from a patient or a patient's medical provider, and wherein the data elements identify the medical good to be provided to the patient;
wherein the system is configured to validate the data elements and create an order for the medical goods from the data elements; and
wherein the system is configured to automatically execute a third party supplier selection routine to select a third party supplier of medical goods capable of providing the medical goods to the patient.

13. The system of claim 12, wherein the system is configured to be accessible by the patient, the physician, or the third party provider through a patient access portal.

14. The system of claim 12, wherein the system is configured to be accessible by the third party supplier through a supplier access portal.

15. The system of claim 12, wherein the system is configured to transmit the order to the third party suppler of medical goods.

16. The system of claim 15, wherein the supplier selected by the third party supplier selection routine is capable of obtaining payment for the medical goods based on information in the order.

17. The system of claim 15, wherein the system if capable of transmitting electronic acknowledgements to the patient or the physician.

18. The system of claim 17, wherein the electronic acknowledgment is transmitted to the patient or the physician by electronic mail, SMS, or MMS text.

19. The system of claim 15, wherein the system is configured to re-direct the order to an alternative third party supplier if the order is rejected by the third party supplier initially selected by the third party supplier selection routine.
